(19) United States
(12) Patent Application Publication
(10) Pub. No.: US 2013/0309488 A1
(43) Pub. Date: Nov. 21, 2013

(54) RESIN MOLDED BODY AND METHOD OF MANUFACTURING SAME

(71) Applicant: Suzuki Motor Corporation, Shizuoka-Ken (JP)

(72) Inventors: Yunosuke FUKAMI, Shizuoka-Ken (JP); Tsunehisa KIMURA, Kyoto (JP); Fumiko KIMURA, Kyoto (JP)

(21) Appl. No.: 13/886,529

(22) Filed: May 3, 2013

(30) Foreign Application Priority Data
May 17, 2012 (JP) 2012-113792

(51) Int. Cl. B44D 5/10

(52) U.S. Cl. CPC B44D 5/10
USPC 428/338; 264/437; 428/221

(57) ABSTRACT

A resin molded body includes a polymeric material, such as one of a thermoplastic resin, a thermosetting resin, elastomer, and rubber, to which a required amount of ferromagnetic glittering agent having shape anisotropy is added. At a time when the polymeric material is in a molten resin state inside of a mold cavity, the polymeric material is subjected to the three-axis orientation control and orientation distribution control performed by applying a rotating magnetic field to the molten resin at a required position, adjusting an orientation of the ferromagnetic glittering agent mixed in the molten resin, and shifting the ferromagnetic glittering agent mixed in the molten resin in a required direction, and the ferromagnetic glittering agent mixed in the molten resin is then shifted to a design surface side to be thereby concentratedly distributed for orientation.

### BACKGROUND OF THE INVENTION

1. Field of the Invention

The present invention relates to a resin material coloring technique using a ferromagnetic glittering agent or material added to a molten resin, and more particularly, to a resin molded body and a method of manufacturing the same. The resin molded body is formed by applying a desired rotating magnetic field to a shape-anisotropic ferromagnetic glittering agent added to the viscous body of a molten resin. The resin molded body can exhibit metallic texture and glittering appearance leading to high-quality texture, and can suppress a defect in external appearance.

2. Related Art

In recent years, colored resin materials are increasingly used for external appearance as resin molded bodies, for the purpose of a reduction in volatile organic compounds in terms of environmental measures and reduction in costs of resin components. The colored resin materials are not subjected to surface treatment such as coating and are colored in themselves to be used for molding in the colored state.

In particular, a colored resin material that is generally frequently used in order to obtain a resin molded body for external appearance with high-quality texture contains a glittering agent (coloring agent) such as metallic powder, glass flakes or mica and is colored to provide pearl metallic color, silver metallic color, or gun metallic color. Such a colored resin material can impart glittering appearance and pearly texture to the obtained resin molded body.

In order to obtain a resin molded body with glittering appearance, it is required for a glittering agent added to the resin molded body to effectively reflect light on its smooth surface. For this reason, it is preferable that the glittering agent have not a spherical shape without a smooth surface, like a ball, but have a plate-like shape. Generally distributed glittering agents are processed into particulate scale-like shapes having shape anisotropy.

In general, a rate of adding a glittering agent to a colored resin molded body (addition rate) is approximately 0.1 to several percent. Because the glittering agent is uniformly dispersed in a molten resin, even if the glittering agent is added to the resin molded body, the amount of glittering agent that can be visually observed in the vicinity of the resin molded body surface is significantly small in comparison with its total addition rate. Hence, if the addition rate of the glittering agent is as small as 0.1 to several percent, it is insufficient to impart metallic texture and glittering appearance to the resin molded body. That is, the imparted metallic texture and glittering appearance are limited.

The metallic texture can be improved by increasing the addition rate of the glittering agent. Unfortunately, if the addition rate thereof is increased, physical properties and functions as the resin material are impaired and economic efficiency is hence impaired due to the increase in costs.

For a resin molded body made of a resin material to which only a small percent of a glittering agent is added, only with mottled glittering appearance which is obtained by the glittering agent dispersedly distributed on the molded body surface, it is impossible to exhibit metallic texture and glittering appearance equal to or more than those achieved by coating, for example, a glittering appearance of 3 or more in terms of a flip-flop value.

Furthermore since the glittering agent is molded and processed in a scale-like state in order to exhibit metallic texture, change in the external appearance during visual observation depending on the orientation of the glittering agent is remarkable. For a resin injection-molded body that is frequently used, the orientation of the glittering agent is changed by resin collision or the like during the injection-molding, so that a weld line, a sink mark, and a flow mark occur on the molded body surface.

If the weld line and the like occur in the resin molded body, a defect or trouble in the external appearance unique to the resin molded body easily shows up.

In conventional technology, there is provided a method of: dispersing an electrically conductive material in a fluent body such as a solidifiable hot-melt resin; applying a time-varying magnetic field to the electrically conductive material; and orienting the electrically conductive material by means of a magnetic interaction between an induction magnetic field made by an induced current generated in the electrically conductive material and the time-varying magnetic field, such as disclosed in Patent Document 1 (Japanese Patent Laid-Open No. 2008-71495).

Furthermore, Patent Document 2 (Japanese Patent Laid-Open No. 2006-57055) describes a method of: placing a short-fiber suspended material suspended in a suspension medium (liquid) in a static magnetic field; applying an elliptically rotating magnetic field thereto; and controlling the orientation of the suspended material.

Patent Document 3 (Japanese Patent Laid-Open No. 2006-264316) describes a method of: applying a rotating magnetic field to a slurry in which non-ferromagnetic ceramic crystal particles are dispersed in a solvent; and controlling the orientation of the non-(ferro)magnetic particles.

Patent Document 4 (Japanese Patent Laid-Open No. 10-95026) describes a method of manufacturing a metallic resin product, the method including: injecting, into a mold cavity, a molten resin in which a magnetic glittering agent (metal flakes) is mixed in a resin material; and alternately generating the magnetic force of a magnet to move the magnetic glittering agent inside of the molten resin to thereby prevent the weld mark from occurring.

Patent Document 5 (Japanese Patent Laid-Open No. 2-295665) describes a method of: cooling a short-fiber metal composite material mixed in a semi-molten cast metal inside of a mold cavity while applying a rotating magnetic field thereto; and manufacturing a metal matrix composite in which the short-fibers are oriented in a predetermined direction. The method described in Patent Document 5 is not a resin material coloring technique.

According to the invention described in Patent Document 1, the orientation of the electrically conductive material is controlled by means of the interaction between the current induced in the electrically conductive material and the time-varying magnetic field applied to the electrically conductive material.

Further, in the inventions described in Patent Documents 2 and 3, although a dynamic magnetic field that is a rotating magnetic field is used, these inventions are directed respectively to short fibers of carbon fiber and polyethylene and a non-magnetic body of non-ferromagnetic ceramic crystals for controlling the orientation using the anisotropic magnetic susceptibility of the non-magnetic crystals, thus being not directed to the shape anisotropy of a magnetic body.

Meanwhile, the metallic texture and glittering appearance of a resin molded body can be improved by increasing the addition rate of a glittering agent of metal. Unfortunately, in this case, physical properties and functions as the resin material are impaired, and economic efficiency is impaired due to the increase in costs.

On the other hand, there exists a technique of imparting metallic texture and glittering appearance to an externally apparent resin molded body without increasing the addition rate of a glittering agent such as metallic powder, glass flakes, and mica powder added to the viscous body of a molten resin and without performing surface treatment such as coating. However, even if only a small percent of the glittering agent is added, it is not possible to impart sufficient metallic texture and glittering appearance (for example, 3 or more in terms of a flip-flop value), so that the resin molded body cannot provide high-quality texture with metallic texture and glittering appearance.

Furthermore, in these days, any techniques for three-axis orientation control and orientation distribution control are not known. In the three-axis orientation control, the orientation of a ferromagnetic glittering agent in the viscous body of a molten resin is adjusted using the shape anisotropy of the ferromagnetic glittering agent. In the orientation distribution control, the ferromagnetic glittering agent is shifted in a desired direction to be thereby concentratedly distributed on one side.

### SUMMARY OF THE INVENTION

The present invention was conceived in consideration of the circumstances encountered in the prior art mentioned above and an object thereof is to provide a resin molded body and a method of manufacturing the same, in which a ferromagnetic added to the viscous body of a molten resin is molded by performing three-axis orientation control and orientation distribution control to thereby exhibit metallic texture and glittering appearance leading to high-quality texture.

In the three-axis orientation control, the orientation of the ferromagnetic glittering agent is adjusted by applying a required rotating magnetic field, and in the orientation distribution control, the ferromagnetic glittering agent is shifted so as to be concentratedly distributed (i.e., in a concentrated manner).

According to the present invention, the above and other objects can be achieved by providing, in one aspect, a resin molded body including a polymeric material to which a required amount of ferromagnetic glittering agent having shape anisotropy is added, in which the polymeric material is one of a thermoplastic resin, a thermosetting resin, elastomer, and rubber, wherein, at a time when the polymeric material is in a molten resin state inside of a mold cavity, the polymeric material is subjected to the three-axis orientation control and orientation distribution control performed by applying a rotating magnetic field to the molten resin at a required position, adjusting an orientation of the ferromagnetic glittering agent mixed in the molten resin, and shifting the ferromagnetic glittering agent mixed in the molten resin in a required direction, and the ferromagnetic glittering agent mixed in the molten resin is shifted to a design surface side to be thereby concentratedly distributed for orientation.

In the above aspect, it may be desired that a required amount of the ferromagnetic glittering agent added to the polymeric material is 0.1 to 10 wt %, and the ferromagnetic glittering agent is in a scale-like state and has an average particle diameter of 1 μm to 200 μm and an aspect ratio of 10 to 1,000.

It may be also desired that the three-axis orientation control is performed by applying the rotating magnetic field to the molten resin of the polymeric material to which the ferromagnetic glittering agent is added, and the orientation of the ferromagnetic glittering agent mixed in the molten resin is adjusted in a same direction.

It may be further desired that the orientation distribution control is performed by applying the rotating magnetic field to the molten resin of the polymeric material to which the ferromagnetic glittering agent is added, and imparting a magnetic field gradient in a plate thickness direction of the resin molded body, and the ferromagnetic glittering agent mixed in the molten resin is shifted to a vicinity of the design surface to be thereby concentratedly distributed for orientation.

The rotating magnetic field may be controlled by one of a rotator portion for a magnet, a rotator portion for the mold cavity, and a switching device for a magnetic field direction so as to directly or indirectly achieve a rotating speed of 200 rpm.

In another aspect of the present invention, there is also provided a method of manufacturing a resin molded body, comprising: preparing one of a thermoplastic resin, a thermosetting resin, elastomer, and rubber as a polymeric material to which a ferromagnetic glittering agent having shape anisotropy is added; setting the polymeric material into a mold cavity; bringing the polymeric material into a molten resin state during molding and processing of the polymeric material; applying a rotating magnetic field to the molten resin; and performing a three-axis orientation control involving adjusting an orientation of the ferromagnetic glittering agent mixed in the molten resin in a same direction to thereby form a resin molded body.

In this aspect, there may be further include: bringing the polymeric material into the molten resin state during the molding and processing of the polymeric material; applying the rotating magnetic field to the molten resin; imparting a magnetic field gradient in a plate thickness direction of the resin molded body; and performing an orientation distribution control so that the ferromagnetic glittering agent mixed in the molten resin is shifted and concentratedly distributed to one side to thereby form the resin molded body.

According to the present invention, when the polymeric material is in the molten resin state, the resin molded body is formed through the three-axis orientation control and the orientation distribution control by applying a required rotating magnetic field. Hence, the orientation of the ferromagnetic glittering agent mixed in the molten resin is two-dimensionally adjusted, and the ferromagnetic glittering agent mixed in the molten resin is shifted in a required direction to be thereby concentratedly distributed. The resin molded body thus formed can exhibit excellent metallic texture and glittering appearance equal to or more than those achieved by coating and also provide a high-quality texture.

Further, the present invention can prevent a weld line, a sink mark, a flow mark, and the like, from occurring, unique to resins, can suppress defect or failure in external appearance of the resin molded body, and does not require any coating process and a plating process. Accordingly, the present invention can provide the resin molded body that can reduce emission of environmentally hazardous substances, which is free from peel-off and rust problems, and does not require coating and plating.

The nature and further characteristic feature of the present invention will be made clearer from the following descriptions made with reference to the accompanying drawings.

### BRIEF DESCRIPTION OF THE DRAWINGS

FIG. 1 is a conceptual view illustrating the shape anisotropy of a ferromagnetic glittering agent (metallic powder) added to a resin molded body;

FIG. 2A is an explanatory view illustrating three-axis orientation control in which the orientation of the ferromagnetic glittering agent in a molten resin is adjusted by applying a rotating magnetic field, and FIG. 2B is an explanatory view illustrating orientation (alignment) distribution control in which the ferromagnetic glittering agent is shifted so as to be concentratedly distributed in the vicinity of a design surface;

FIG. 3A is an enlarged cross sectional view illustrating a resin molded body containing a ferromagnetic glittering agent the orientation of which is not uniform, and FIG. 3B is an enlarged cross sectional view illustrating a resin molded body of an embodiment of the present invention, in which all particles of a ferromagnetic glittering agent are oriented and distributed in the vicinity of a design surface by applying a required rotating magnetic field;

FIG. 4A is a plan view illustrating a metallic resin component or parts obtained from the resin molded body in FIG. 3A, and FIG. 4B is a plan view illustrating a metallic resin component or parts obtained from the resin molded body in FIG. 3B according to the embodiment of the present invention;

FIG. 5A is a cross sectional view illustrating a plated resin molded body, and FIG. 5B is a plan view illustrating the metallic resin component obtained from the plated resin molded body;

FIG. 6A is an enlarged cross sectional view partially illustrating a resin molded body having a base material surface on which a plating layer is formed, and FIG. 6B is an enlarged cross sectional view partially illustrating a resin molded body having a design surface in the vicinity of which the orientation (alignment) and distribution of a ferromagnetic glittering agent is controlled;

FIG. 7A is a perspective view illustrating an example of a resin molded body formed by performing normal injection-molding on a molten resin, and FIG. 7B is a perspective view illustrating an example of a resin molded body formed by injection-molding a molten resin while applying a magnetic field thereto;

FIG. 8A is a schematic perspective view illustrating a rotating magnetic field apparatus that forms a resin molded body, and FIG. 8B is a schematic front view illustrating the rotating magnetic field apparatus in FIG. 8A;

FIG. 9A is a schematic plan view illustrating another example of the rotating magnetic field apparatus, and FIG. 9B is a schematic front view illustrating the rotating magnetic field apparatus in FIG. 9A;

FIG. 10 is a diagram for describing a relationship in arrangement between the magnetic field distribution in the rotating magnetic field apparatus and a sample (resin molded body);

FIG. 11A is a view illustrating an orientation pattern example of a ferromagnetic glittering agent to which a magnetic field is applied, and FIG. 11B is a view illustrating an orientation pattern example of a ferromagnetic glittering agent that does not rotate;

FIG. 12 is an explanatory view for describing a moment at which particles of a ferromagnetic glittering agent are attracted from each other due to the application of a magnetic field;

FIG. 13 is an explanatory view for describing a moment at which particles of a ferromagnetic glittering agent are repelled from each other due to the application of a magnetic field;

FIG. 14 is a photograph showing a sample (resin molded body) surface on which particles of a ferromagnetic glittering agent are stacked on each other;

FIG. 15 is a photograph showing an upper surface of a sample of Example 1 that is put in a glass container before the application of a magnetic field;

FIG. 16 is a photograph showing the upper surface of the sample (resin molded body) of Example 1 after an experiment;

FIG. 17 is a photograph showing a surface of a normal injection-molded body formed by injection-molding the sample of Example 1;

FIG. 18 is a photograph showing the external appearance of the upper surface of the sample (resin molded body) of Example 1 after the experiment;

FIG. 19 is a photograph showing the external appearance of a side surface of the sample (resin molded body) of Example 1 after the experiment;

FIG. 20 is a photograph showing a lower surface (bottom surface) of the sample of Example 1 after the experiment;

FIG. 21 is a photograph showing the external appearance of an upper surface of a sample (resin molded body) of Example 2 after an experiment;

FIG. 22 is a photograph showing a cross section of the sample (resin molded body) of Example 2 after the experiment;

FIG. 23 is a photograph showing the external appearance of a side surface of the sample (resin molded body) of Example 2 after the experiment;

FIG. 24 is a photograph showing the external appearance of a sample of Example 3 before an experiment (before applying the magnetic field); and

FIG. 25 is a photograph showing the external appearance of the sample of Example 3 after the experiment (after applying the magnetic field).

### DESCRIPTION OF THE PREFERRED EMBODIMENT

Hereunder, an embodiment of a resin molded body and a method of manufacturing the same according to the present invention will be described with reference to the accompanying drawings.

The present invention relates to a resin material coloring technique in which an externally apparent resin molded body is formed using a ferromagnetic glittering agent added to the viscous body of a fluent substance so as to exhibit metallic texture and glittering appearance leading to high-quality texture. More specifically, the present invention provides a resin molded body and a method of manufacturing the same, in which the resin molded body is formed by: applying, at a required position, a rotating magnetic field to the viscous body (in the case of a resin, the viscoelastic body) of a polymeric (resin) material such as a plastic resin material, a thermosetting resin material, elastomer, or rubber to which a required amount of ferromagnetic glittering agent is added; and performing three-axis orientation control and orientation (alignment) distribution control thereon. The resin molded body thus formed can exhibit metallic texture and glittering appearance leading to high-quality texture, and can suppress a trouble in external appearance.

The present invention of the characters mentioned above will be more specifically explained hereunder.

### [Fluent Substance]

Examples of the used fluent substance include polymeric (resin) materials such as a plastic resin material, a thermosetting resin material, an elastomer, and a rubber. A resin material is selected as the polymeric material capable of obtaining a polymeric molded body satisfying required mechanical physical properties, thermal properties, electrical properties, optical properties, and the like.

Examples of the fluent substance used in the present embodiment include polymeric materials such as a curable thermoplastic resin, a thermosetting resin, elastomer, and rubber.

The thermoplastic resin include, as examples, prepolymers and polymers consisting of vinyl acetate, vinyl alcohol, vinyl butyral, vinyl chloride, acrylic acid, methacrylic acid, styrene, ethylene, amide, cellulose, isobutylene, vinyl ether, and the like. Further, the thermosetting resin also include, as examples, prepolymers and polymers consisting of urea, melamine, phenol, resorcinol, epoxy, imide, and the like.

It is further preferred that the melt viscosity of the viscous body of a molten resin as the fluent substance be low for the reason such that the three-axis orientation control and the orientation (alignment) distribution control on the ferromagnetic glittering agent added to the viscous body can be easily performed.

[Ferromagnetic Glittering Agent]

Metal having a high magnetic susceptibility is preferable for the ferromagnetic glittering agent or material.

The ferromagnetic glittering agent used in the present embodiment include, as examples, scale-like ferromagnetic metal and non-magnetic metal such as aluminum coated with the scale-like ferromagnetic metal. The ferromagnetic material include, as examples, iron, cobalt, nickel, and alloys thereof.

The three-axis orientation control and the orientation distribution control can be performed even in non-magnetic metal such as aluminum as long as a stronger magnetic flux density and a stronger magnetic field are applied to the non-magnetic metal. An example material most suitable for the ferromagnetic glittering agent is PC permalloy (78% Ni-22% Fe). The PC permalloy is a material having a high magnetic susceptibility (60,000). Accordingly, scale-like PC permalloy, which is a Ni—Fe alloy having a high magnetic susceptibility, is a material preferable for the scale-like ferromagnetic metal and the ferromagnetic glittering agent coated therewith.

[Relation Between Moving Speed U and Orientation Time τ of Ferromagnetic Glittering Agent]

The moving speed U (m/s) and the orientation time i (s) of the ferromagnetic glittering agent added and mixed into the fluent substance are both significantly influenced by a viscosity η (Pa·s) of the molten resin, and the relation therebetween can be expressed by the following expressions.

U=V·x/(μoη·K)·B·dB/dz (1)

τ=L·η·μo/(V·N·x·B²) (2)

where V denotes the volume (m³) of the ferromagnetic glittering agent;

x denotes the volume magnetic susceptibility of the ferromagnetic glittering agent;

μo denotes the magnetic permeability in vacuum (H/m); K denotes the tensor depending on the shape of the ferromagnetic glittering agent with regard to the movement of the ferromagnetic glittering agent;

B denotes the magnetic flux density (T);

dB/dz denotes the magnetic field gradient (T/m);

L denotes the tensor depending on the shape of the ferromagnetic glittering agent with regard to the orientation of the ferromagnetic glittering agent; and

N denotes the diamagnetic field coefficient.

It is understood from the Expressions (1) and (2) that the moving speed U and the orientation time τ of the ferromagnetic glittering agent are both significantly influenced by the magnetic susceptibility of the ferromagnetic glittering agent.

[Shape Anisotropy of Ferromagnetic Glittering Agent]

A ferromagnetic glittering agent 10 added to the viscous body of a resin as the fluent substance has a tabular shape anisotropy and is configured in a scale-like state in order to efficiently perform the three-axis orientation control and the orientation (alignment) distribution control by applying a rotating magnetic field at a required position.

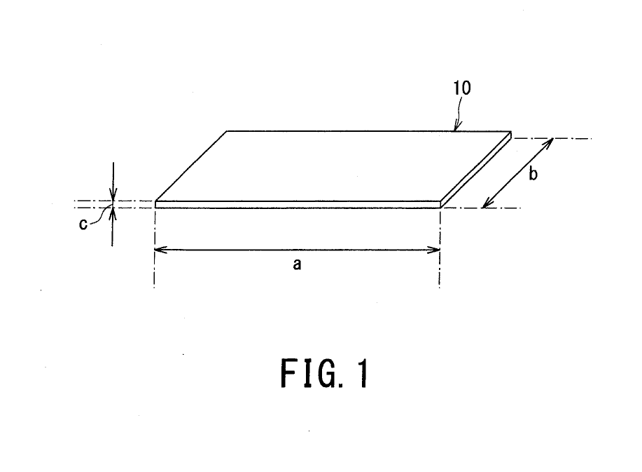

Specifically, the ferromagnetic glittering agent 10 is configured as scale-like ferromagnetic metal and a material coated therewith having such shape anisotropy as illustrated in FIG. 1, in which the lengths of sides a, b, and c of the ferromagnetic glittering agent 10 are different (a≠b≠c).

[Resin Molded Body]

The resin molded body of the present embodiment is formed by adding 0.1 to 10 wt % of the ferromagnetic glittering agent 10 to the viscous body of the molten resin made of a polymeric (resin) material such as a thermoplastic resin material, a thermosetting resin material, an elastomer, or a rubber. The ferromagnetic glittering agent 10 has an average particle diameter of 1 μm to 200 μm and an aspect ratio of 10 to 1,000. In the state where the ferromagnetic glittering agent 10 is uniformly dispersed and molten in the molten resin, a rotating magnetic field is applied to the molten resin at a required position, whereby the three-axis orientation control and the orientation (alignment) distribution control are performed thereon.

In the three-axis orientation control, all the scale-like particles of the ferromagnetic glittering agent 10 are oriented in the same direction. In the orientation (alignment) distribution control, the ferromagnetic glittering agent 10 is shifted to one side (design surface side) in the molten resin so as to be concentratedly distributed (i.e., in a concentrated manner).

According to the present embodiment, a required amount of the scale-like ferromagnetic glittering agent 10 having shape anisotropy is added to the polymeric material such as a thermoplastic resin material or a thermosetting resin material. Then, the resultant material is housed in a mold cavity inside of a resin molded body manufacturing apparatus, and the mold cavity is a mold housing portion made of non-magnetic metal and the like. A rotating magnetic field is applied to the resultant material at a required position by a rotating magnetic field apparatus (to be described herein later) as the resin molded body manufacturing apparatus.

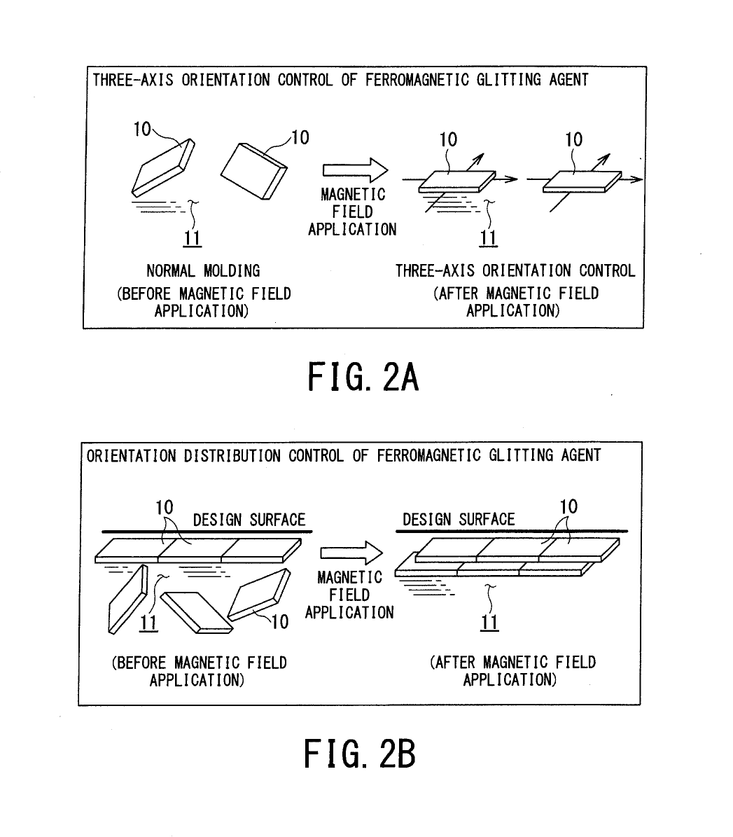

As illustrated in FIG. 2A, the three-axis orientation control is performed such that all the particles of the ferromagnetic glittering agent 10 (metallic powder) mixed in a molten resin 11 of the polymeric material are oriented in the same direction. Further, as illustrated in FIG. 2B, a required magnetic field gradient (inclined magnetic field) is required to the rotating magnetic field, whereby the ferromagnetic glittering agent 10 is shifted to one side (design surface side) in the molten resin 11 so as to be concentratedly distributed for orientation. According to the manner mentioned above, the resin molded body of the present embodiment can exhibit metallic texture and glittering appearance superior in high-quality texture, and can suppress defect or trouble in external appearance unique to the resin molded body.

The present embodiment relates to a resin material coloring technique. According to the resin material coloring technique, magnetic field application conditions are appropriately adjusted for performing the three-axis orientation control and the orientation distribution control on the ferromagnetic glittering agent 10 (metallic powder) mixed in the molten resin 11 inside of the mold cavity. Consequently, a resin molded body 12 thus formed can exhibit metallic texture and glittering appearance having high-quality texture (plating texture).

In a normal molding process, the ferromagnetic glittering agent 10 is added and dispersed into the molten resin 11, and the resultant material is molded. In this case, as illustrated in FIG. 2A, the orientation of the ferromagnetic glittering agent 10 is not uniform.

In contrast, if a rotating magnetic field is applied with the magnetic field application conditions being appropriately adjusted, the three-axis orientation control can be performed such that all the particles of the ferromagnetic glittering agent 10 are oriented in the same direction. Furthermore, if a magnetic field gradient is required to the rotating magnetic field, as illustrated in FIG. 2B, the orientation (alignment) distribution control can be performed such that the ferromagnetic glittering agent 10 having non-uniform orientation in the molten resin 11 is shifted to the vicinity of the design surface to be thereby concentratedly distributed.

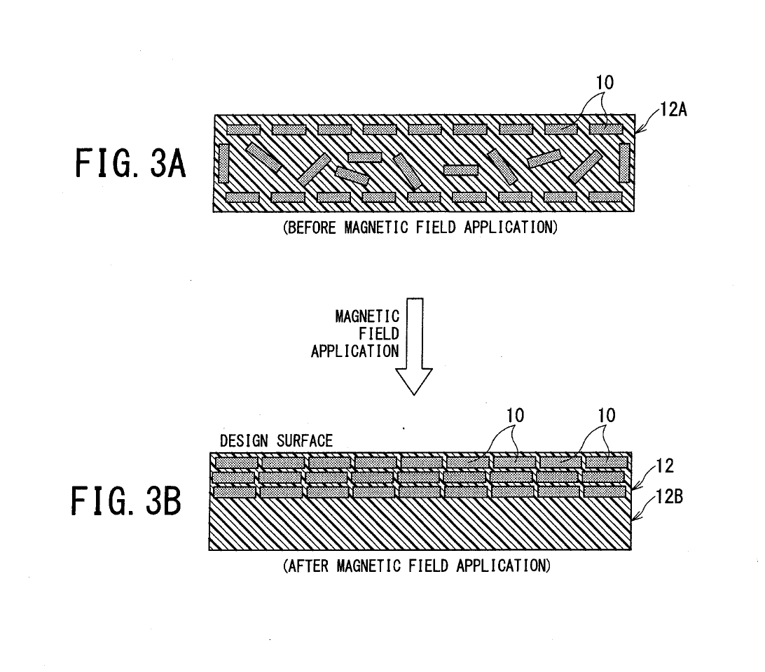

As illustrated in FIG. 3A, in a resin molded body 12A that is the resin molded body 12 before the magnetic field application, the orientation of the ferromagnetic glittering agent 10 in the molten resin 11 is not uniform, and hence the resin molded body 12A cannot exhibit metallic texture and glittering appearance. If a rotating magnetic field is applied to the molten resin 11 at a required position, as illustrated in FIG. 3B, the orientation distribution control is performed after the magnetic field application such that all the particles of the ferromagnetic glittering agent 10 are shifted to the vicinity of the design surface to be thereby concentratedly distributed. The resin molded body 12 thus formed can exhibit metallic texture and glittering appearance and can provide an external surface with high-quality texture.

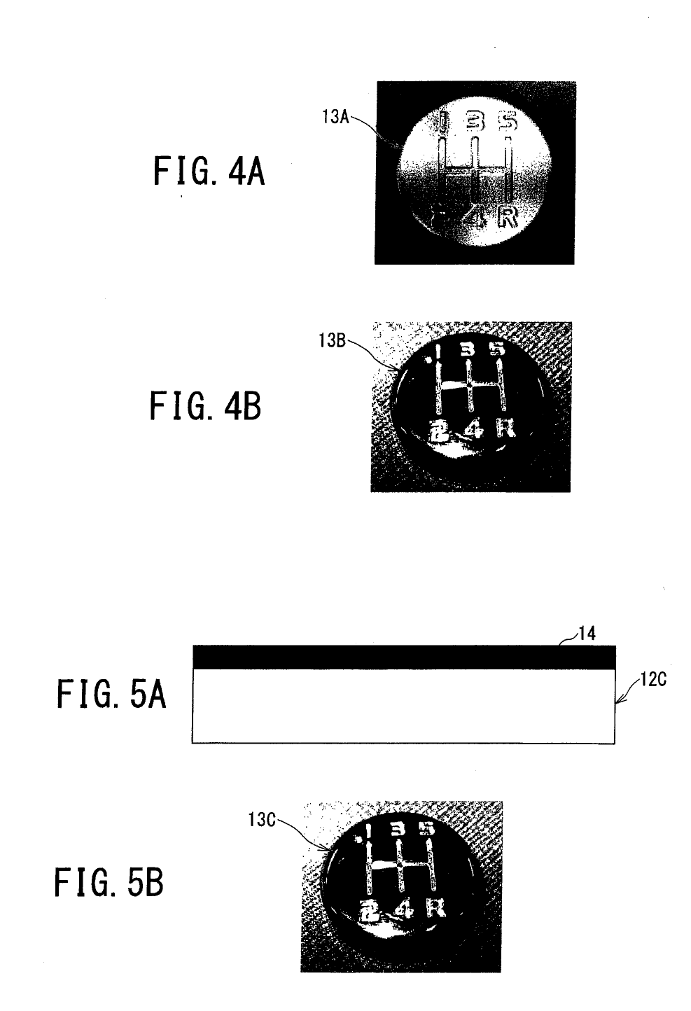

FIGS. 4A and 4B each illustrate a resin component applied to a head portion of a shift lever of an automobile. A resin component 13A in FIG. 4A is a metallic resin component that cannot exhibit metallic texture and glittering appearance. The resin component 13A is obtained from the resin molded body 12A in FIG. 3A to which a magnetic field is not applied. In the resin component 13A, the orientation of the ferromagnetic glittering agent 10 inside of the resin molded body 12A is not uniform, and hence, the resin component 13A cannot exhibit plating texture corresponding to metallic texture and glittering appearance.

In contrast, a resin component 13B in FIG. 4B, representing the present embodiment, is a metallic resin component that can exhibit plating texture corresponding to metallic texture and glittering appearance. The resin component 13B is obtained from the resin molded body 12 (12B) in FIG. 3B after the magnetic field application. For the resin component 13B, if a gradient in the rotating magnetic field is applied to the molten resin 11 at a required position, the orientation distribution of the ferromagnetic glittering agent 10 after the magnetic field application is controlled.

As a result, as illustrated in FIG. 3B, the ferromagnetic glittering agent 10 is shifted to the vicinity of the design surface to be thereby concentratedly distributed for orientation. After the magnetic field application, the molten resin 11 containing the ferromagnetic glittering agent 10 whose orientation (alignment) distribution has been controlled is molded, whereby the resin molded body 12B illustrated in FIG. 3B is obtained. The resin component 13B in FIG. 4B, according to the present embodiment, that can exhibit plating texture corresponding to metallic texture and glittering appearance can be obtained from the resin molded body 12 (12B) thus obtained.

Meanwhile, it is discussed to metal-plate a resin molded body 12C made of the molten resin 11 to thereby form a plating layer 14 thereon, instead of adding and mixing the ferromagnetic glittering agent 10 into the molten resin 11. In this case, as illustrated in FIG. 5A, metal is deposited on a base material surface of the resin molded body 12C, and, as illustrated in FIG. 5B, the resin component 13C obtained from the resin molded body 12C can exhibit plating texture corresponding to metallic texture and glittering appearance. The resin component 13C illustrated in FIG. 5B can exhibit metallic texture and glittering appearance substantially equivalent to those of the resin component 13B illustrated in FIG. 4B.

However, the metal (plated) portion of the plated resin component 13C illustrated in FIG. 5B is exposed on the component surface and is likely to hit against something, thus being easily damaged, peeled off or scared.

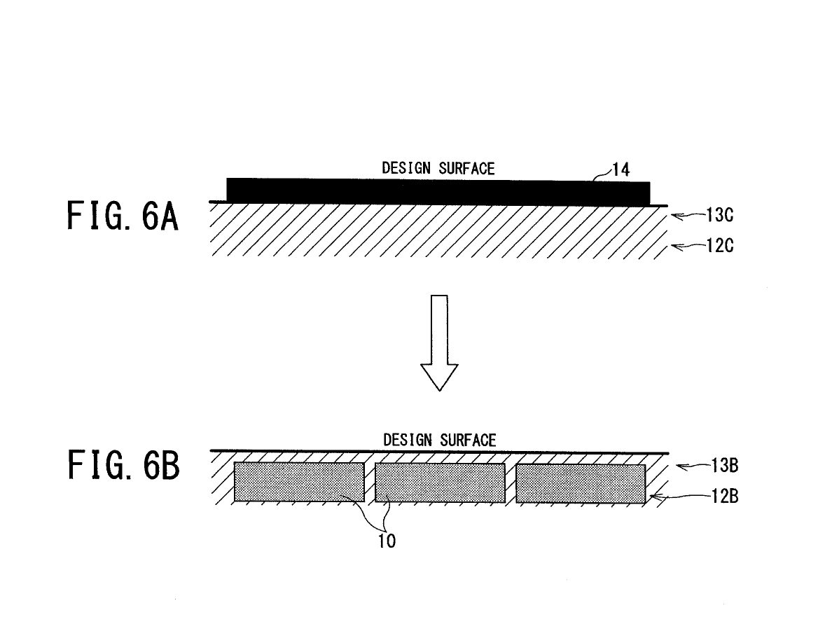

Specifically, as illustrated in FIG. 6A, the plating layer 14 of the plated resin component 13C is exposed on the base material surface, and is likely to hit against something, thus being easily damaged, peeled off or scared.

In contrast, in the resin component 13B illustrated in FIG. 6B, the orientation (alignment) distribution control is performed, through the application of a required rotating magnetic field, such that the ferromagnetic glittering agent 10 is shifted and concentrated to the vicinity of the design surface. Hence, the ferromagnetic glittering agent 10 in the resin component 13B, which is concentratedly distributed in the vicinity of the design surface inside of the resin molded body 12B, does not hit against something, thus preventing the plating layer from being peeled off and rusted, and hence, providing an improved quality thereof.

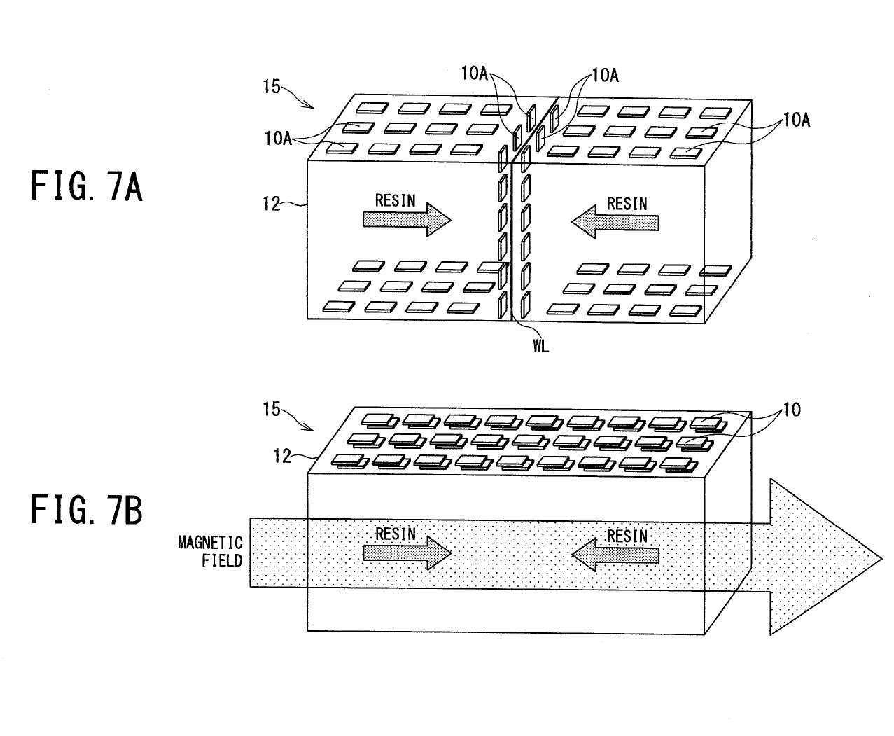

In general, the resin component 13 is formed by adding a glittering agent 10A (coloring agent) to the molten resin 11 and injection-molding the resultant material. As illustrated in FIG. 7A, the resin component 13 is formed as a colored resin component in many cases. Unfortunately, in the colored resin component 13, the orientation of the glittering agent 10A is changed by resin collision or the like during the normal injection-molding treatment, so that a weld line WL, a sink mark, and a flow mark occur on the molded body surface. Therefore, the resin molded body 12 forming the resin component 13 may become defective in external appearance unique to the resin molded body due to the occurrence of the weld line WL and the like.

In contrast, if the injection-molding treatment is performed with a magnetic field being applied to the molten resin 11, as illustrated in FIG. 7B, all the particles of the ferromagnetic glittering agent 10 are oriented in the same direction. Hence, the resin molded body 12 is formed without causing any weld line, and defective or failure in external appearance unique to the resin molded body is suppressed from being generated.

Meanwhile, before the magnetic field application, as illustrated in FIG. 3A, the resin molded body 12 forming the metallic resin component 13 provides a cross sectional structure of the resin molded body 12A, in which the ferromagnetic glittering agent 10 is mixed in a randomly dispersed state.

After the magnetic field application, the ferromagnetic glittering agent 10 is shifted to one side in the molten resin 11 to be thereby concentratedly distributed. In this state, the three-axis orientation control and the orientation (alignment) distribution control are performed in the combined manner, thereby forming the resin molded body 12B. The resin molded body 12 (12B) after the magnetic field application is formed to have a cross sectional shape equivalent to that of the metal-plated resin molded body 12C. In this sense, the metallic resin component obtained from the resin molded body 12B can be regarded as an alternative to a plated component.

In the present embodiment, the following four points will be listed up as basic and essential subject features.

(1) The resin material forming the resin molded body 12 is a thermoplastic resin material or a thermosetting resin material to which 0.1 to 10 wt % of the ferromagnetic glittering agent 10 is added, and the ferromagnetic glittering agent 10 having an average particles diameter of 1 μm to 200 μm and an aspect ratio of 10 to 1,000 is obtained.

(2) There is provided a method of manufacturing a resin molded body, the method including the steps of: bringing a resin material into a molten resin state during the molding process and processing of the resin material; applying a rotating magnetic field to the molten resin 11; and performing the three-axis orientation control involving adjustment of the orientation of the ferromagnetic glittering agent 10 mixed in the molten resin 11 in the same direction, and through these steps, the resin molded body 12 can be manufactured.

(3) There is provided a method of manufacturing a resin molded body, the method including the steps of: bringing a resin material into a molten resin state during the molding process and processing of the resin material; applying, by a rotating magnetic field apparatus 15 or 16, a rotating magnetic field to the molten resin; imparting a magnetic field gradient (inclined magnetic field) in a plate thickness direction of the resin molded body 12; and distributing the ferromagnetic glittering agent 10 mixed in the molten resin 11 to the same side (surface side) in the concentrated manner, and through these steps, the resin molding body 12 can be manufactured.

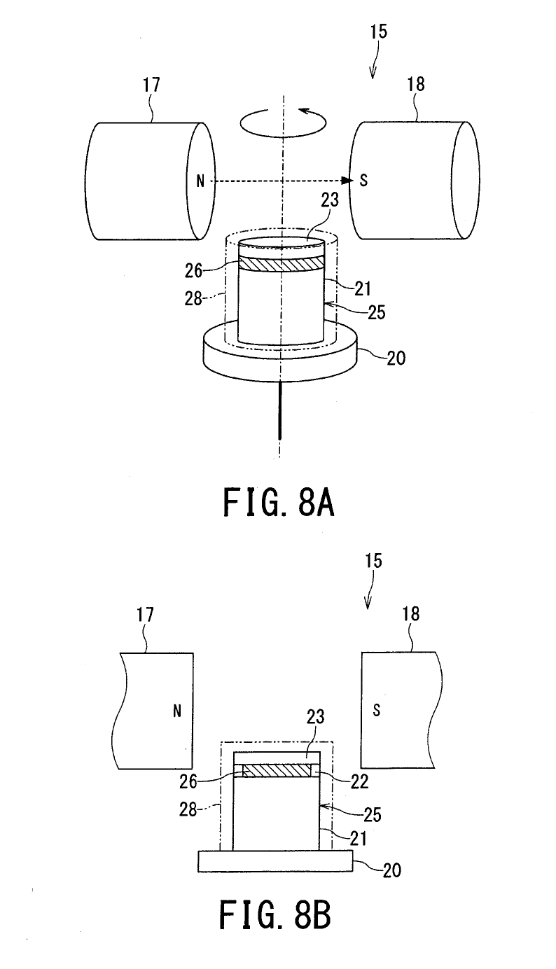

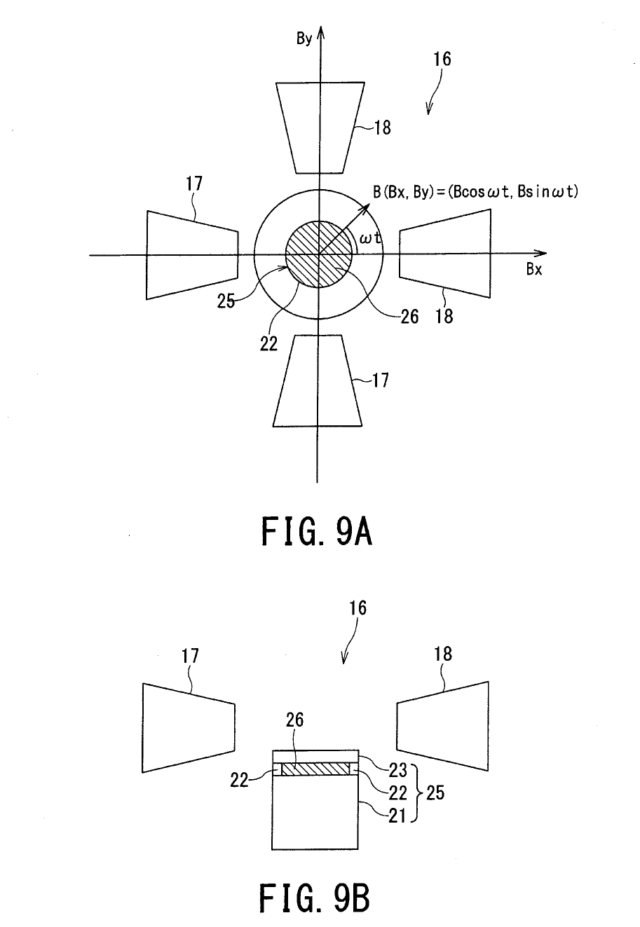

(4) The resin molded body manufacturing apparatus includes: a non-magnetic mold housing portion (mold cavity) that molds a resin material; a magnet such as a permanent magnet or an electromagnet that applies a magnetic field; a rotator portion that imparts rotation to at least one of the housing portion and the magnet; and a controlling device that controls heating temperature for forming a molten resin from the resin material housed in the housing portion and imparting a rotation of, for example, 200 rpm or more to the rotator portion. The rotating magnetic field apparatus 15 and 16 (see FIG. 8 and FIG. 9) may be constructed so as to control the rotation of the rotator portion for the housing portion or the rotator portion for the magnet to thereby apply a rotating magnetic field of 200 rpm, and may be constructed so as to control the switching of the direction of a magnetic field, like an electromagnet, to thereby apply the magnetic field corresponding to the rotating magnetic field.

The basic subject features (2) and (3) of the present embodiment are implemented by the rotating magnetic field apparatus 15 and 16 respectively illustrated in FIG. 8 and FIG. 9.

As illustrated in FIGS. 8A and 8B, in the rotating magnetic field apparatus 15, magnetic poles (two poles) 17 and 18 of an N-pole and an S-pole constituting a dipole are arranged to be opposed to each other in the diametrical direction. A rotating table 20 is provided, for example, in a lower area between the magnetic poles 17 and 18 of the N-pole and the S-pole, and the rotating table 20 is rotationally driven by a driving device, not shown.

A sample stage 21 is provided on the rotating table 20. The sample stage 21, a torus-shaped or sleeve-shaped spacer 22, and a sample stage holding member (cover) 23 constitute a container 25 as the non-magnetic mold housing portion, and the mold cavity (space) for housing a sample 26 is formed inside of the container 25. The mold cavity formed inside of the non-magnetic container 25 may have various shapes, for example, a cylindrical shape and a discoid shape as a molding space.

Examples of the resin material used as the sample 26 include polymeric (resin) materials such as a thermoplastic resin material, a thermosetting resin material, elastomer, and rubber.

In the rotating magnetic field apparatus 15, the dipole magnetic poles 17 and 18 or the sample 26 is rotationally driven at a required rotating speed, for example, a rotating speed corresponding to 200 rpm or more, whereby a rotating magnetic field is applied to the sample 26.

Further, the container 25 (mold cavity) that is disposed on the rotating table 20 and is filled with the sample 26 is housed in a heating device 28 as needed. The heating device 28 can adjust and control the heating temperature of the container 25. Depending on the type of the sample 26 housed in the mold cavity of the container 25, the heating device 28 adjusts and controls the heating temperature so as to produce the optimal molten resin 11 having a small viscosity.

In the case where a homopolypropylene resin (thermoplastic resin material) is used for the sample 26, the heating device 28 heats the container 25 to, for example, 200° C. In the case where a room-temperature for curing liquid silicone rubber is used for the sample 26, a rotating magnetic field is applied by the rotating magnetic field apparatus 15 to the target between the magnetic poles 17 and 18 for a predetermined period of time, for example, for two minutes. After such magnetic field application, the target is left for a predetermined period of time, for example, for 24 hours while a hot air dryer as the heating device 28 is operated at 80° C., whereby the resin molded body 12 is manufactured.

In the rotating magnetic field apparatus 16 illustrated in FIGS. 9A and 9B, another pair of the magnetic poles 17 and 18 are also placed so as to be opposed to each other, at a position rotated by 90 degrees from the position of the opposed magnetic poles 17 and 18, in addition to the rotating magnetic field apparatus 15 illustrated in FIG. 8. Assuming that the opposed magnetic poles 17 and 18 are paired, a sine-wave magnetic field is applied to an area between one pair of the magnetic poles 17 and 18, and a cosine-wave magnetic field is applied to an area between another pair of the magnetic poles 17 and 18, and as a result, a rotating magnetic field can be applied as a whole.

The other elements are the same as those in the rotating magnetic field apparatus 15 illustrated in FIG. 8. Hence, the same elements or parts are denoted by the same reference numerals, and duplicated, description will be omitted herein.

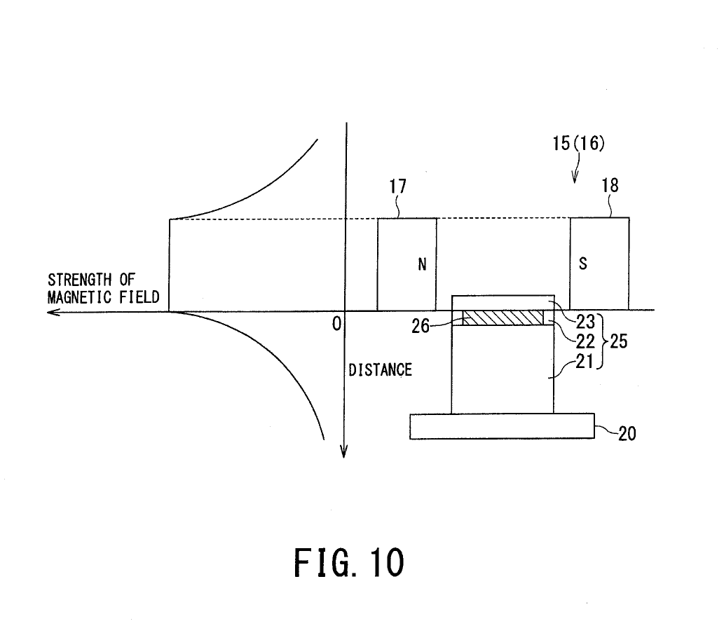

Meanwhile, 0.1 to 10 wt % of the ferromagnetic glittering agent (metallic powder) 10 having an average particle diameter of 1 μm to 200 μm and an aspect ratio of 10 to 1,000 is added to the resin material such as a thermoplastic resin or a thermosetting resin used as the sample 26. With the use of the property of the ferromagnetic glittering agent 10, which is attracted to a higher magnetic field gradient side, as shown in FIG. 10, the sample 26 is arranged so as to be opposed to the position and the region in which a magnetic field gradient exists. The magnetic field (magnetic flux density) between the magnetic poles 17 and 18 is substantially constant (uniform), and hence, a magnetic field gradient does not exist therebetween. Accordingly, the sample 26 can be disposed outside of the area between the magnetic poles 17 and 18.

In the case where the sample 26 is placed in the area having the uniform magnetic flux density between the magnetic poles 17 and 18, the three-axis orientation control (see FIG. 2A) on the scale-like ferromagnetic glittering agent 10 having shape anisotropy is possible, whereas it is impossible to perform the orientation (alignment) distribution control (see FIG. 2B) thereon. In the orientation (alignment) distribution control, the ferromagnetic glittering agent 10 is shifted to one side, for example, upward in the molten resin 11 of the sample 26 to be thereby concentratedly distributed.

As illustrated in the magnetic field distribution in FIG. 10, the magnetic flux density between the magnetic poles 17 and 18 is substantially constant and uniform, and hence, a magnetic field gradient does not exist therebetween. A magnetic field gradient exists outside of the area between the magnetic poles 17 and 18. The magnetic flux density has a magnetic field gradient that exponentially becomes smaller with increasing distance from the area between the magnetic poles 17 and 18. In other words, the magnetic field gradient becomes larger with decreasing distance from the magnetic poles 17 and 18. The molten resin 11 of the sample 26 is disposed at a position with the larger magnetic field gradient.

The rotating magnetic field apparatus 15 and 16 shown respectively as illustrations in FIGS. 8 and 9 are used to perform the three-axis orientation control on the ferromagnetic glittering agent 10 added and mixed into the molten resin 11 of the sample 26 to perform the orientation (alignment) distribution control for shift movement in a required direction and concentrated distribution.

According to the sample placement examples in the rotating magnetic field apparatus 15 and 16 respectively illustrated in FIG. 8B and FIG. 9B, the ferromagnetic glittering agent 10 added to the molten resin 11 of the sample 26 is moved upward in the respective drawings inside of the molten resin 11.

According to such examples as mentioned above, as illustrated in FIG. 10, the uppermost surface (design surface) of the sample 26 housed in the container 25 (mold cavity) is set at a position with the largest magnetic field gradient around the magnetic poles 17, and in other words, set at a position that is closest to and outside of the area between the magnetic poles 17 and 18. That is, a position with the highest magnetic flux density of the rotating magnetic field can be defined as the design surface position of the resin molded body. Even if the sample 26 is set at a position slightly apart from the area between the magnetic poles 17 and 18, an effect of shifting the ferromagnetic glittering agent 10 to one side can be obtained, but the magnetic field gradient of the magnetic flux density is lower, which is not preferable.

Further, the three-axis orientation control and the orientation distribution control for shift movement and concentrated distribution are performed on the ferromagnetic glittering agent 10 added to the sample 26. In the rotating magnetic field apparatus 15 and 16 respectively illustrated in FIGS. 8 and 9, the rotating table 20 may be moved vertical direction (i.e., upward/downward) or may be done while being rotated together.

Meanwhile, the reason why a rotating magnetic field is applied to the sample 26 in the container 25 (mold cavity) by the rotating magnetic field apparatus 15 or 16 resides in the smooth performance of the three-axis orientation control (FIG. 2A) for orientation adjustment and of the orientation (alignment) distribution control (FIG. 2B) through the shift movement and concentrated distribution, on the ferromagnetic glittering agent 10 added to the molten resin 11.

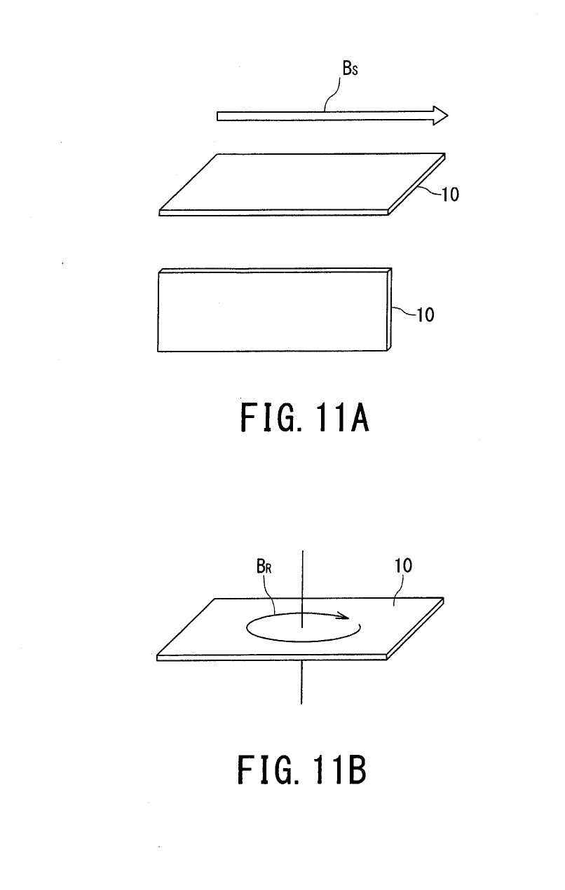

In the case where a magnetic field is applied to the scale-like ferromagnetic glittering agent 10 having such shape anisotropy (a b c) as illustrated in FIG. 1, the direction of the magnetic field is parallel to the longitudinal direction of the ferromagnetic glittering agent (ferromagnetic metallic powder) 10 as illustrated in FIG. 11A. On the other hand, if a unidirectional magnetic field is applied, one-axis control can be performed on the ferromagnetic glittering agent 10. In this case, however, smooth surfaces (ab surfaces) of the particles of the ferromagnetic glittering agent 10 cannot be controlled so as to be oriented in the same direction.

In order to orient the smooth surfaces (ab surfaces) of all the particles of the ferromagnetic glittering agent 10 in the same direction, as illustrated in FIG. 11B, a rotating magnetic field B_{R} is applied. Through such rotating magnetic field application, as illustrated in FIG. 2A, the smooth surfaces (ab surfaces) of all the particles of the ferromagnetic glittering agent 10 are oriented in the same direction.

That is, if a magnetic field is applied to the ferromagnetic glittering agent 10 in one direction, as illustrated in FIG. 11A, the longitudinal direction of the ferromagnetic glittering agent 10 coincides with the direction of the applied magnetic field. Then, if the rotating magnetic field B_{R} is applied thereto, as illustrated in FIG. 11B, the ferromagnetic glittering agent 10 is oriented into the easiest rotation pattern. In this way, the three-axis orientation control is performed on the ferromagnetic glittering agent 10.

More specifically, if the rotating magnetic field B_{R} that rotates the magnetic field is applied, the ferromagnetic glittering agent 10 accordingly rotates because the longitudinal direction thereof tries to become parallel to the applied rotating magnetic field. At this time, the ferromagnetic glittering agent 10 is oriented into the easiest rotation pattern, so that the three-axis orientation control illustrated in FIG. 2A and the orientation distribution control illustrated in FIG. 2B are performed on the ferromagnetic glittering agent 10 having shape anisotropy.

The rotating magnetic field and the inclined magnetic field are applied to the molten resin 11 at a required position, whereby the ferromagnetic glittering agent 10 is shifted to one side in the molten resin 11 to be thereby concentratedly distributed in an aligned state. Hence, the molding process is performed with the three-axis orientation control and the orientation (alignment) distribution control being performed.

[Influence of Rotating Speed of Rotating Magnetic Field]

If a static magnetic field is applied to the ferromagnetic glittering agent 10 in the molten resin 11, the ferromagnetic glittering agent 10 is cured. Parts of the cured ferromagnetic glittering agent 10 try to be unified with and stacked on another parts thereof magnetized around the first mentioned parts.

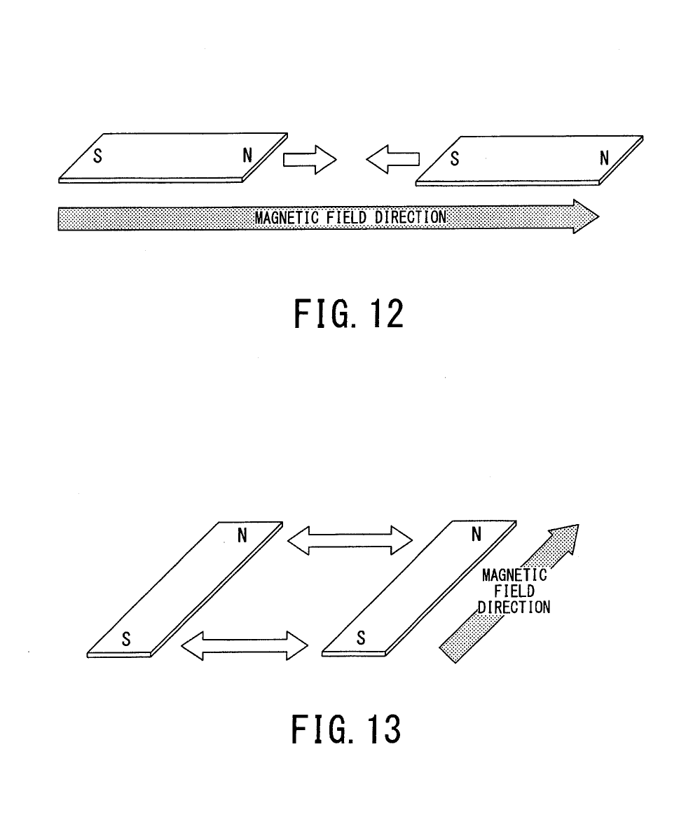

In the present embodiment, if a rotating magnetic field is applied to the ferromagnetic glittering agent 10 added to the molten resin 11, due to the rotation of the magnetic field, the direction of the magnetic field applied to the ferromagnetic glittering agent 10 changes at the moment at which the particles of the magnetized ferromagnetic glittering agent 10 attract each other as illustrated in FIG. 12. Thus, as illustrated in FIG. 13, the particles of the magnetized ferromagnetic glittering agent 10 repel each other.

Accordingly, the particles of the cured ferromagnetic glittering agent 10 are prevented from being stacked on each other.

It is however to be noted that, in the case where the rotating speed of the magnetic field is low, the particles of the cured ferromagnetic glittering agent 10 are stacked on each other, and hence, it is necessary to apply a rotating magnetic field having an appropriate rotating speed to the ferromagnetic glittering agent 10.

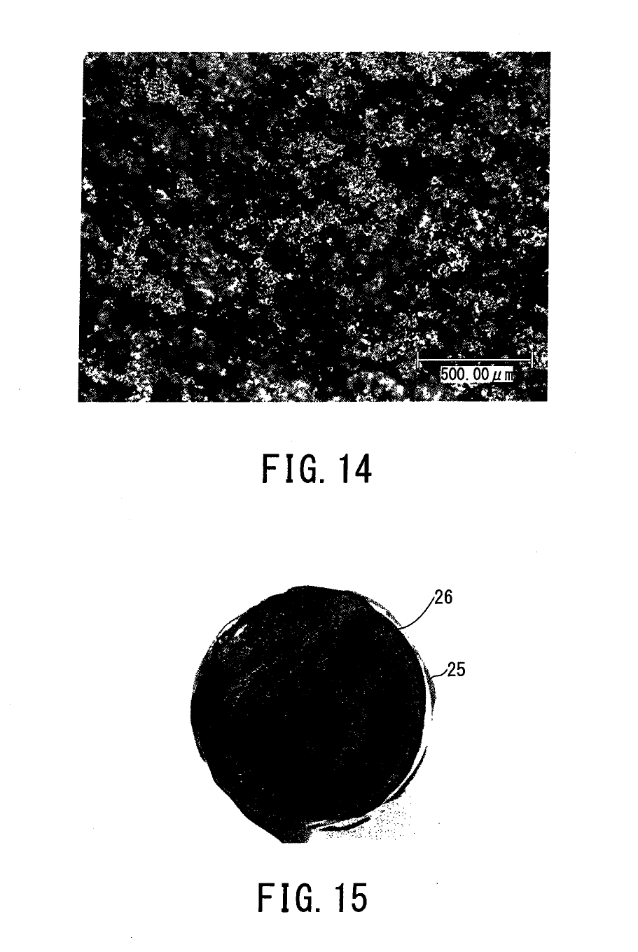

As the rotating speed of the rotating magnetic field is higher, the particles of the ferromagnetic glittering agent 10 are less likely to be stacked on each other. An experiment proves that a rotation of 200 rpm or more is necessary to prevent such stacking. The experiment proves that, in the case where the rotating speed of the rotating magnetic field is less than 200 rpm, the particles of the ferromagnetic glittering agent 10 are stacked on each other on the surface of the molten resin 11 and that the external appearance is impaired. FIG. 14 is a photograph showing the surface of the sample 26 on which the particles of the ferromagnetic glittering agent 10 are stacked on each other.

### Effects of Embodiment

According to the resin molded body and the method of manufacturing the same of the present embodiment, the magnetic field application conditions are regulated for the rotating magnetic field applied to the particulate or powdery scale-like ferromagnetic glittering agent 10 added to the molten resin 11 of the fluent substance. Therefore, the three-axis orientation control and the orientation (alignment) distribution control for concentrated distribution can be performed on the ferromagnetic glittering agent 10. Accordingly, without performing the plating and coating treatment, the material colored resin component obtained from the resin molded body 12 thus formed can exhibit metallic texture and glittering appearance equivalent to or more than those achieved by coating treatment.

The method of manufacturing the resin molded body 12 does not require a coating process and a plating process, thus being free from peel-off and rust problems. Further, the method of manufacturing the resin molded body 12 can suppress a weld line, a sink mark, a flow mark, and the like from occurring in the colored resin molded body 12, thereby suppressing defect or failure in external appearance of the resin molded body which is unique to the resin component.

In addition, an addition rate of the ferromagnetic glittering agent 10 can be as low as 10% or less, the addition rate being required to enable the colored resin molded body 12 to exhibit metallic texture and glittering appearance. Hence, the metallic resin component can be provided while maintaining the physical properties and functions as the resin material.

Hereunder, specific examples of the resin molded body and the method of manufacturing the same will be described in accordance with experiments.

### Example 1

A room-temperature curing-type liquid silicone rubber having a viscosity of 100 Pa·s was prepared for the resin material as the sample 26. Scale-like PC permalloy flakes having an average particle diameter of 24 μm and an aspect ratio of 40 were prepared for the ferromagnetic glittering agent 10. Then, the prepared ferromagnetic glittering agent 10 was added and uniformly dispersed into the prepared sample 26 to thereby obtain a slurry. The addition rate of the ferromagnetic glittering agent 10 was as low as 10 wt % or less, for example, 2 wt %. The slurry thus obtained was poured into the non-magnetic glass container 25 (mold cavity) having a diameter of 20 mm and a thickness of 2 mm, and the container 25 was set on the rotating table 20 of the rotating magnetic field apparatus 15 illustrated in FIGS. 8A and 8B. In this state, an experiment was carried out.

Then, in the rotating magnetic field apparatus 15 illustrated in FIGS. 8A and 8B, a rotating magnetic field was applied to the target with a magnetic flux density of 1 tesla (T) between the magnetic poles 17 and 18 of the magnets, for two minutes at a rotating speed of 40 rpm. After such magnetic field application, the target was left for 24 hours while a hot air dryer as the heating device 28 being operated at 80° C. The resultant resin molded body 12, which was obtained in a solidified state, exhibited metallic texture and glittering appearance on the upper surface of the sample 26 that were obviously improved compared with those on the sample 26 before the magnetic field application in a visual observation.

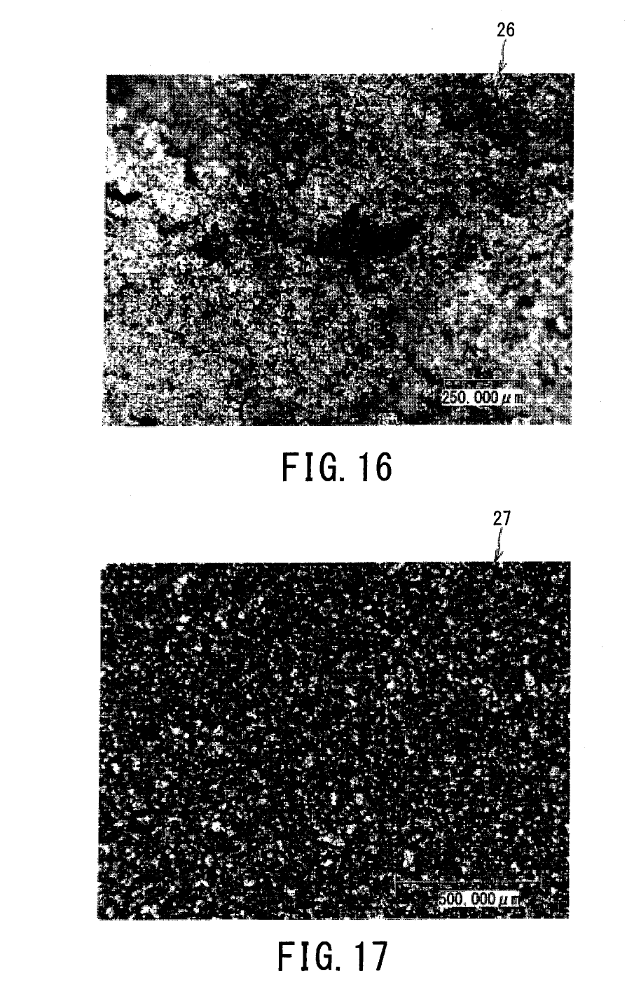

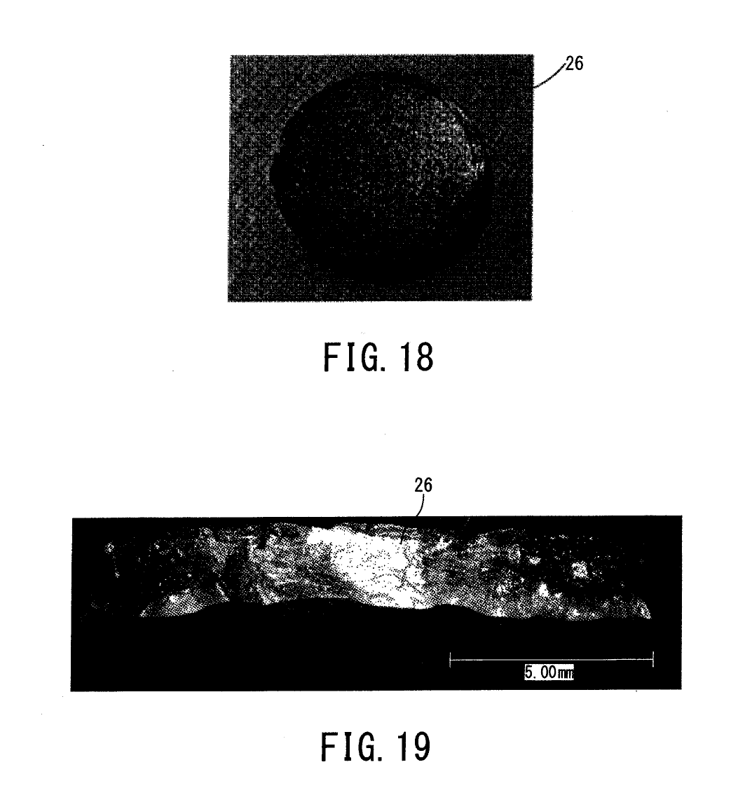

FIG. 16 is a photograph showing the upper surface of the resin molded body 12 as the sample 26 after the experiment. In the photograph of FIG. 16, compared with the surface of a normal injection-molded body 27 shown in FIG. 17, the ferromagnetic glittering agent is closely and densely packed with substantially no gap, and the metallic texture and glittering appearance leading to the high-quality texture are achieved. As shown in FIG. 16 and FIG. 18, because the ferromagnetic glittering agent 10 is closely and densely packed with substantially no gap, the upper surface of the sample 26 after the experiment can exhibit the improved metallic texture and glittering appearance leading to the high-quality texture.

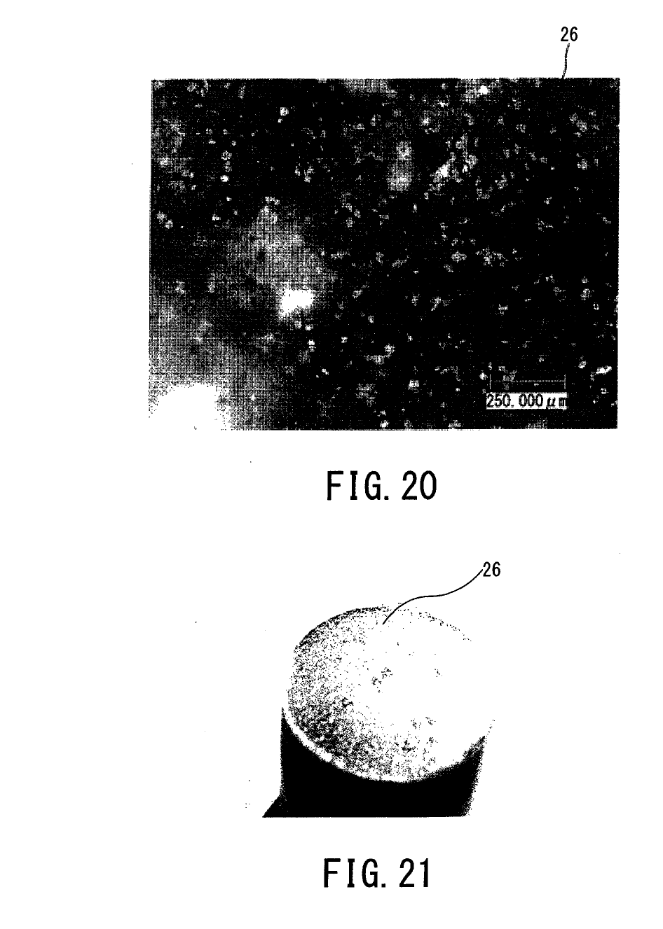

Further, when the sample 26 is observed from the side thereof side, as shown in FIG. 19, the sample upper portion looks black, and the sample lower portion has a resin color of the silicone rubber. Furthermore, as shown in FIG. 20, almost no ferromagnetic glittering agent 10 exists on the lower surface of the sample 26.

Further, attention is paid on the ferromagnetic glittering agent 10 added to the sample 26, as illustrated in FIG. 1, the ab surface has the most glittering appearance, and light reflecting areas of the ac surface and the bc surface are smaller than that of the ab surface. Hence, the ac surface and the bc surface look black in the visual observation.

In consideration of the above matters, it will be understood from the observation results of FIG. 16, FIG. 18, and FIG. 19 that the orientation distribution control is performed on the PC permalloy flakes as the ferromagnetic glittering agent 10 in the state where the ab surface having a more glittering appearance faces the sample upper surface and where the ac surface and the bc surface each having a less glittering appearance face the sample side surfaces.

Further, because the sample lower portion has the silicone rubber color when the sample 26 is observed from the side thereof, it is obvious that the PC permalloy flakes dispersedly exhibited before the magnetic field application are moved to the sample upper portion.

It was proved that the resin material coloring technique could provide the resin molded body 12 that could exhibit high metallic texture and glittering appearance leading to high-quality texture. According to the resin material coloring technique, the resin molded body 12 is formed by applying a rotating magnetic field to the molten resin 11 of the sample 26 at a required position and performing the three-axis orientation control and the orientation (alignment) distribution control on the ferromagnetic glittering agent 10. One of the parameters that represent the metallic texture and glittering appearance of the resin molded body 12 is a flip-flop value (FF value) shown in the following Table 1.

TABLE 1
Flip-Flop Value (FF Value) Representing Metallic Texture

| | Injection- | Present | |
|---|---|---|---|
| | Molded Body | Embodiment | |
| | Surface | (FIGS. 16 | Silver Color |
| | (FIG. 17) | and 18) | Coated Body |
| FF | 2.4 | 4 | 2.8 |
| Value | | | |

The flip-flop value (FF value) roughly indicates as follows:

In the case of a FF value <3, the material colored resin component can exhibit metallic texture equivalent to that of the coated resin component.

In the case of an FF value 3, the material colored resin component can exhibit metallic texture equal to or more than that of the coated resin component.

In the case of an FF value=6, the material colored resin component can exhibit metallic texture equivalent to that achieved by half(semi)-bright plating at the maximum.

The FF value of the sample 26 of Example 1 after the experiment is 4, and hence, a metallic resin component that can exhibit the metallic texture and glittering appearance equal to or more than those of the coated resin component can be obtained.

### Example 2

With regard to the three-axis orientation control on the ferromagnetic glittering agent, an experiment was carried out using the rotating magnetic field apparatus 16 illustrated in FIGS. 9A and 9B, in order to prove that the ab surfaces of all the particles of the ferromagnetic glittering agent 10 added to the resin material as the sample 26 faced the upper surface of the sample 26 (three-axis orientation control state). In the rotating magnetic field apparatus 16, the sample 26 was set in the area between the magnetic poles 17 and 18, the area having a uniform magnetic field without a magnetic field gradient. The experiment was carried out using the rotating magnetic field apparatus 16 under the condition that only the three-axis orientation control was performed on the permalloy flakes as the ferromagnetic glittering agent 10 added to the molten resin 11.

The scale-like PC permalloy flakes (ferromagnetic glittering agent 10) having an average particle diameter of 24 μm and an aspect ratio of 40 were added and uniformly dispersed into an urethane UV curing resin (the resin material as the sample 26) having a viscosity of 100 Pa·s to thereby obtain a slurry. The addition rate of the ferromagnetic glittering agent 10 was as low as 10 wt % or less, for example, 2 wt %. The slurry thus obtained was poured into the non-magnetic container 25 (mold cavity) having a diameter of 8 mm and a thickness of 10 mm, and a rotating magnetic field was applied to the target with a magnetic flux density of 0.3 T between the magnetic poles 17 and 18 for one second at a rotating speed of 240 rpm. After such magnetic field application, the target was irradiated with ultraviolet rays (UV) in a curing process.

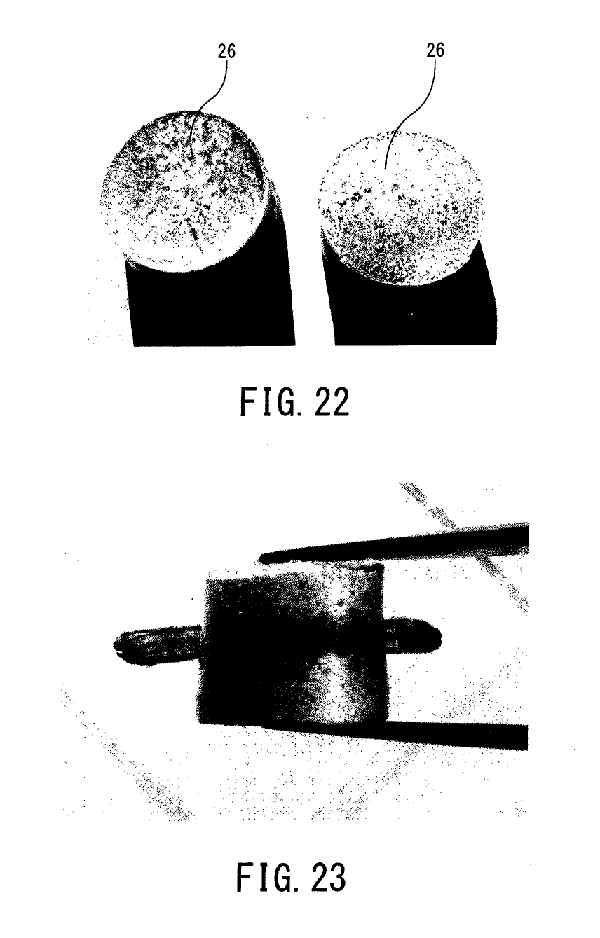

FIG. 21 is a photograph showing the external appearance of the upper surface of the sample 26 after the experiment, and FIG. 22 is a photograph showing a cross section of the sample 26 after the experiment. In both the photographs, the high metallic texture is achieved. Further, as shown in FIG. 23, the sample 26 is semi-transparent and blackish when being observed from the side thereof. That is, light is reflected on the sample upper surface, whereas light is transmitted through the sample side surfaces. Accordingly, it is proved that, in the shape-anisotropic scale-like ferromagnetic glittering agent 10 enlargedly illustrated in FIG. 1, the ab surface having a more glittering appearance faces the sample upper surface or the sample lower surface, and the ac surface and the be surface each having a less glittering appearance face the sample side surfaces (i.e., the three-axis orientation control is performed on the ferromagnetic glittering agent 10).

### Example 3

With regard to the orientation distribution control on the ferromagnetic glittering agent, a corroborative experiment concerning shift movement was carried out using the PC permalloy flakes as the ferromagnetic glittering agent 10 of Example 1, in order to prove that the orientation (alignment) distribution of the ferromagnetic glittering agent 10 is controlled inside of the molten resin 11 of the sample 26.

In Example 3, the scale-like PC permalloy flakes (ferromagnetic glittering agent 10) having an average particle diameter of 24 μm and an aspect ratio of 40 were added and uniformly dispersed into a room-temperature curing liquid silicone rubber (resin material) having a viscosity of 100 Pa·s, thus obtaining a slurry.

The addition rate of the ferromagnetic glittering agent 10 was low, for example, 2 wt %. Further, an additive-free room-temperature curing liquid silicone rubber was set on the slurry thus obtained. Under this condition, the same experiment as that in Example 1 was carried out.

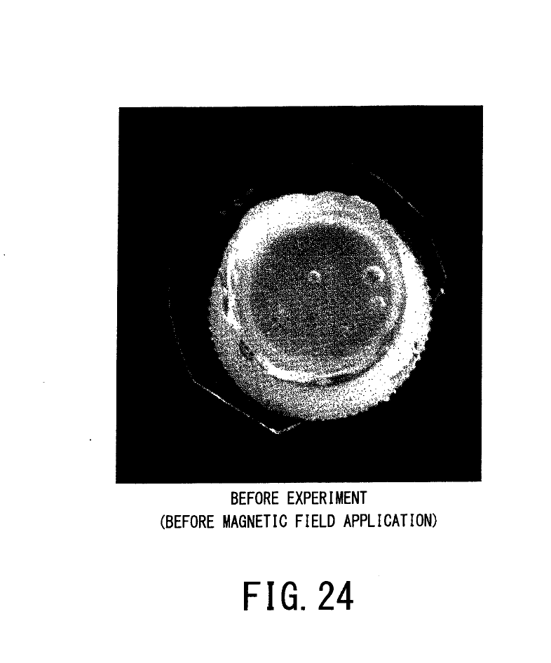

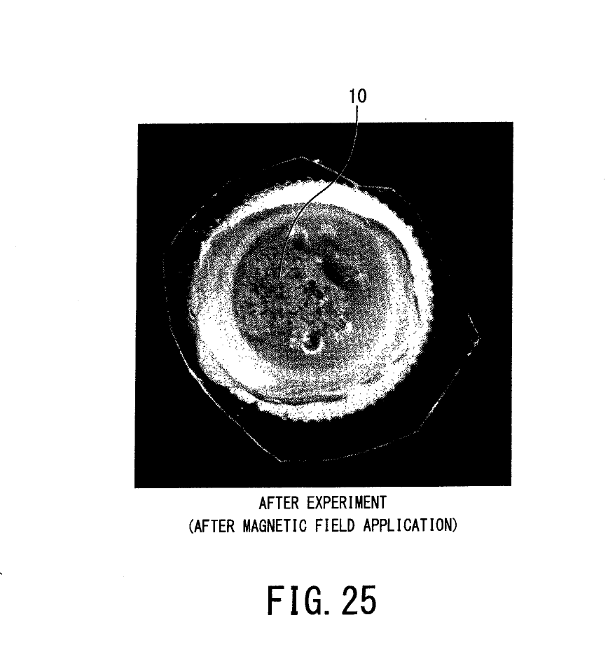

Before the experiment, as shown in FIG. 24, the upper surface of the sample 26 provided a milky white color of the additive-free room-temperature curing liquid silicone rubber. After the experiment, that is, after the magnetic field application, as shown in FIG. 25, the PC permalloy powder (flakes) as the ferromagnetic glittering agent 10 existed on the upper surface of the sample 26. It is obvious that the PC permalloy powder (flakes) passed and was shifted through the additive-free room-temperature curing liquid silicone rubber (resin material) during the experiment using the rotating magnetic field apparatus 15.

### Example 4

The PC permalloy flakes (ferromagnetic glittering agent 10) having an average particle diameter of 24 μm and an aspect ratio of 40 were added and uniformly dispersed into a polypropylene resin (resin material) having a viscosity of 1,000 Pa·s, thus obtaining a pelletized sample. The addition rate of the ferromagnetic glittering agent 10 was a small weight percent, for example, 2 wt %. The pelletized sample thus obtained was injection-molded, thereby forming a molded body of 10×10×2 mm (thickness).

Then, the injection-molded body thus formed was set into the container 25 of the rotating magnetic field apparatus 15 illustrated in FIGS. 8A and 8B, and was heated to 200° C. by the heating device 28. A rotating magnetic field was applied to the target with a magnetic flux density of 1 T between the magnetic poles 17 and 18, for 60 minutes at a rotating table speed of 200 rpm. After such magnetic field application, the target was cooled. In this way, the resin molded body 12 was formed.

According to the result of this experiment, similarly to the resin molded body 12 of Example 1, the resultant resin molded body 12 exhibits metallic texture that is obviously improved in comparison with that of the sample 26 before the magnetic field application, when being visually observed. The sample upper portion looks black, and the sample lower portion provides the propylene color.

### Example 5

The same experiment as that in Example 4 was carried out using an injection-molded body as the resin molded body. The used injection-molded body had a weld line.

When the resin molded body was observed after the experiment, the weld line disappeared.

What is claimed is:

1. A resin molded body including a polymeric material to which a required amount of ferromagnetic glittering agent having shape anisotropy is added, in which the polymeric material is one of a thermoplastic resin, a thermosetting resin, elastomer, and rubber,
wherein, at a time when the polymeric material is in a molten resin state inside of a mold cavity, the polymeric material is subjected to the three-axis orientation control and orientation distribution control performed by applying a rotating magnetic field to the molten resin at a required position, adjusting an orientation of the ferromagnetic glittering agent mixed in the molten resin, and shifting the ferromagnetic glittering agent mixed in the molten resin in a required direction, and the ferromagnetic glittering agent mixed in the molten resin is then shifted to a design surface side to be thereby concentratedly distributed for orientation.

2. The resin molded body according to claim 1, wherein a required amount of the ferromagnetic glittering agent added to the polymeric material is 0.1 to 10 wt %, and the ferromagnetic glittering agent is in a scale-like state and has an average particle diameter of 1 μm to 200 μm and an aspect ratio of 10 to 1,000.

3. The resin molded body according to claim 1, wherein the three-axis orientation control is performed by applying the rotating magnetic field to the molten resin of the polymeric material to which the ferromagnetic glittering agent is added, and the orientation of the ferromagnetic glittering agent mixed in the molten resin is adjusted in a same direction.

4. The resin molded body according to claim 1, wherein the orientation distribution control is performed by applying the rotating magnetic field to the molten resin of the polymeric material to which the ferromagnetic glittering agent is added, and imparting a magnetic field gradient in a plate thickness direction of the resin molded body, and the ferromagnetic glittering agent mixed in the molten resin is shifted to a vicinity of the design surface to be thereby concentratedly distributed for orientation.

5. The resin molded body according to claim 1, wherein the rotating magnetic field is controlled by one of a rotator portion for a magnet, a rotator portion for the mold cavity, and a switching device for a magnetic field direction so as to directly or indirectly achieve a rotating speed of 200 rpm.

6. A method of manufacturing a resin molded body, comprising:
preparing one of a thermoplastic resin, a thermosetting resin, elastomer and rubber as a polymeric material to which a ferromagnetic glittering agent having shape anisotropy is added;
setting the polymeric material into a mold cavity;
bringing the polymeric material into a molten resin state during molding and processing of the polymeric material;
applying a rotating magnetic field to the molten resin; and
performing a three-axis orientation control involving adjusting an orientation of the ferromagnetic glittering agent mixed in the molten resin in a same direction to thereby form a resin molded body.

7. The method of manufacturing a resin molded body according to claim 6, further comprising:
bringing the polymeric material into the molten resin state during the molding and processing of the polymeric material;
applying the rotating magnetic field to the molten resin;
imparting a magnetic field gradient in a plate thickness direction of the resin molded body; and
performing an orientation distribution control so that the ferromagnetic glittering agent mixed in the molten resin is shifted and concentratedly distributed to one side to thereby form the resin molded body.
